(19) United States
(12) Patent Application Publication
(10) Pub. No.: US 2005/0097087 A1
(43) Pub. Date: May 5, 2005

(54) System and method for providing a unified framework for service discovery

(76) Inventors: Murali Krishna Punaganti Venkata, Vantaa (FI); Franklin Reynolds, Bedford, MA (US)

Correspondence Address: Crawford Maunu PLLC;Suite 390, 1270 Northland Drive, St. Paul, MN, 55120, US

(21) Appl. No.: 10/700,365

(22) Filed: Nov. 3, 2003

(51) Int. Cl. G06F 7/00

(52) U.S. Cl. 707/3

(57) ABSTRACT

Service Discovery (SD) agent (208) provides uniform and integrated service discovery operation, whereby a default connection to SD Engine (SDE) (224) may be automatically initiated to aid in service discovery. User agents (UA) (214-216) are installed to implement the various SDP interfaces (314-324) as required. Canonical query transform (310) transforms user queries from query generation tool (302) to the appropriate protocol as needed for SD interfaces (314-324). Likewise, service discovery results from the SD interfaces are translated by canonical query transform (310) into user friendly results for ultimate display to user interface (326).

### FIELD OF THE INVENTION

This invention relates in general to service discovery, and more particularly, to service discovery agents having multiple service discovery protocol interoperability.

### BACKGROUND OF THE INVENTION

The mobile industry has experienced a period of exceptional growth during the last several years, where mobile voice and simple SMS text messaging have provided some of the primary drivers for that growth. As the next generation of mobile network growth evolves, a multitude of services will be offered, where rich content as well as voice, will be transported throughout a combination of mobile and internet environments, using an integrated IP network layer.

An ALL-IP network enables seamless network integration of different access options, e.g., broadband, mobile Internet, fixed Internet, and existing mobile systems, into a single IP layer. As such, all communication services may be carried over a single network infrastructure, thus enabling the integration of voice, data, and multimedia services. Carriers on the ALL-IP networks will glean a number of important benefits as well, including cost savings, scalability, flexibility, efficient network operations, and new revenue opportunities.

The number of services that will become available as a result of this seamless network integration is expected to grow enormously. Besides the classical services, such as those offered by printers, scanners, and fax machines, other network services such as information access, music on demand, and services that use computational infrastructure deployed within the network will be offered.

Following this trend, it becomes increasingly important to give users the possibility of finding and making use of the services that are available in the network. Ideally, users would like to obtain access to services automatically, without requiring their system to be reconfigured. With the widespread deployment of network enabled mobile devices, such as notebooks, Personal Data Assistants (PDAs), and enhanced cellular phones, dynamic discovery of services in a visited foreign network, for example, along with automatic system configuration, will be useful features.

Service Discovery Protocols (SDP) aim to reshape the way software and network resources are configured, deployed, and advertised. The focus is not only to provide a plug and play solution, but to provide an environment in which a device can automatically discover services, including their properties, in a dynamic fashion. Among the emerging SDPs are: Service Location Protocol (SLP), Salutation, Bluetooth, Jini, and Universal Plug and Play (UPnP). Some of the goals for most of the SDPs are to: browse for services having certain attributes; choose the service based upon its attributes; and utilize the service.

Even though each SDP essentially has the same goal, all SDPs inherently have different origins, underlying technologies, flavors, and audiences. In other words, since the developers of these SDPs see the service discovery problem at different angles, the resulting solutions are often substantially divergent from one another. Accordingly, the browsing terminal must either: converse with only those Service Discovery Engines (SDE) that employ the browsing terminal's particular SDP; or conversely, bridge across all SDPs, such that proper service queries may take place regardless of the SDP currently executed by the SDE.

Accordingly, there is a need in the communications industry for a system and method that facilitates comprehensive service discovery. The comprehensive service discovery mechanisms should have the capability to provide a uniform and integrated service discovery experience for the user, such that the multitude of SDPs encountered during a particular service discovery session may be interpreted and presented in a consistent manner.

### SUMMARY OF THE INVENTION

To overcome limitations in the prior art, and to overcome other limitations that will become apparent upon reading and understanding the present specification, the present invention discloses a system and method for providing a comprehensive framework for a uniform and integrated service discovery mechanism.

In accordance with one embodiment of the invention, a method for providing uniform service discovery through the use of a plurality of service discovery protocols is provided. The method comprises generating service discovery queries from a user interface, translating the service discovery queries into formats required by each of the plurality of service discovery protocols, receiving results indicative of services found from each of the plurality of service discovery protocols in response to the service discovery queries, and translating the results into a uniform format for display on the user interface. The uniform format is independent of the plurality of service discovery protocols.

In accordance with another embodiment of the invention, a service discovery system is provided comprising a first service discovery agent coupled to receive service discovery queries in a user format and coupled to transform the user formatted service discovery queries into a plurality of formats each dependent upon a plurality of respective service discovery protocols, and a second service discovery agent coupled to receive service discovery queries from the first service discovery agent and in response, to provide service discovery responses to the first service discovery agent. The second service discovery agent is coupled to access services discovered by the first service discovery agent.

In accordance with another embodiment of the invention, a network host is provided comprising means for receiving service discovery queries from a service discovery agent, means for discovering services within a domain of the network host in response to the service discovery queries, means for providing the services discovered within the domain of the network host to the service discovery agent, and means for accessing services within a domain of the service discovery agent.

In accordance with another embodiment of the invention, a computer-readable medium having instructions stored thereon which are executable by a network host for facilitating service discovery is provided. The instructions performing steps comprising receiving service discovery queries from a service discovery agent, discovering services within a domain of the network host in response to the service discovery queries, providing the services discovered within the domain of the network host to the service discovery agent, and accessing services within a domain of the service discovery agent.

In accordance with another embodiment of the invention, a mobile terminal wirelessly coupled to a network having a service discovery engine is provided. The mobile terminal comprises a memory capable of storing a service discovery agent coupled to locate services having a plurality of service description protocols in response to received user queries having a user format, a processor coupled to the memory and configured by the service discovery agent to enable service discovery query exchange with the service discovery engine, and a transceiver configured to facilitate the service discovery query exchange with the service discovery engine. The transceiver further facilitates access to the services having a plurality of service description protocols by the service discovery engine.

In accordance with another embodiment of the invention, a computer-readable medium having instructions stored thereon which are executable by a mobile terminal for providing service discovery is provided. The instructions performing steps comprising receiving service discovery queries in a user format, transforming the user formatted service discovery queries into a plurality of formats relating to a plurality of service discovery protocols, receiving service discovery results in a plurality of service discovery protocols in response to the service discovery queries, and transforming the service discovery results into the user format.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system and method in accordance with the invention.

### BRIEF DESCRIPTION OF THE DRAWINGS

The invention is described in connection with the embodiments illustrated in the following diagrams.

FIG. 1 illustrates and exemplary system architecture in accordance with the present invention;

FIG. 2 illustrates an exemplary end to end architecture in accordance with the present invention;

FIG. 3 illustrates an exemplary block diagram of a service discovery agent in accordance with the present invention;

FIG. 4 illustrates a hybrid service discovery scenario in accordance with the present invention;

FIG. 5 illustrates an exemplary message flow diagram in accordance with the present invention;

FIG. 6 illustrates an exemplary flow diagram in accordance with the present invention;

FIG. 7 illustrates a representative mobile computing arrangement suitable for providing integrated service discovery in accordance with the present invention; and

FIG. 8 is a representative computing system capable of carrying out service discovery functions according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system and method that provides a unified framework that may be utilized by any network entity, mobile or otherwise, to implement a uniform and integrated service discovery experience. In particular, a service discovery agent is formed, such that the vocabularies and behavior of the various SDPs executing below the service discovery agent may be translated into a uniform and user friendly presentation to the user. Accordingly, the service discovery agent allows new service discovery protocols to be deployed on legacy network terminals already in use. When deployed within a land based network entity, for example, the service discovery agent additionally provides the capability to: gather multiple replies from multiple, land based SDP requests; compile the results into a uniform format; and transmit the uniform results to a requesting mobile terminal. Additionally, the service discovery agent may exist on, for example, Bluetooth enabled mobile terminals, whereby the local service discovery agent communicates with the Bluetooth SDP of the mobile terminal, to formulate proper service discovery requests to remote service discovery agents that do not employ Bluetooth SDP.

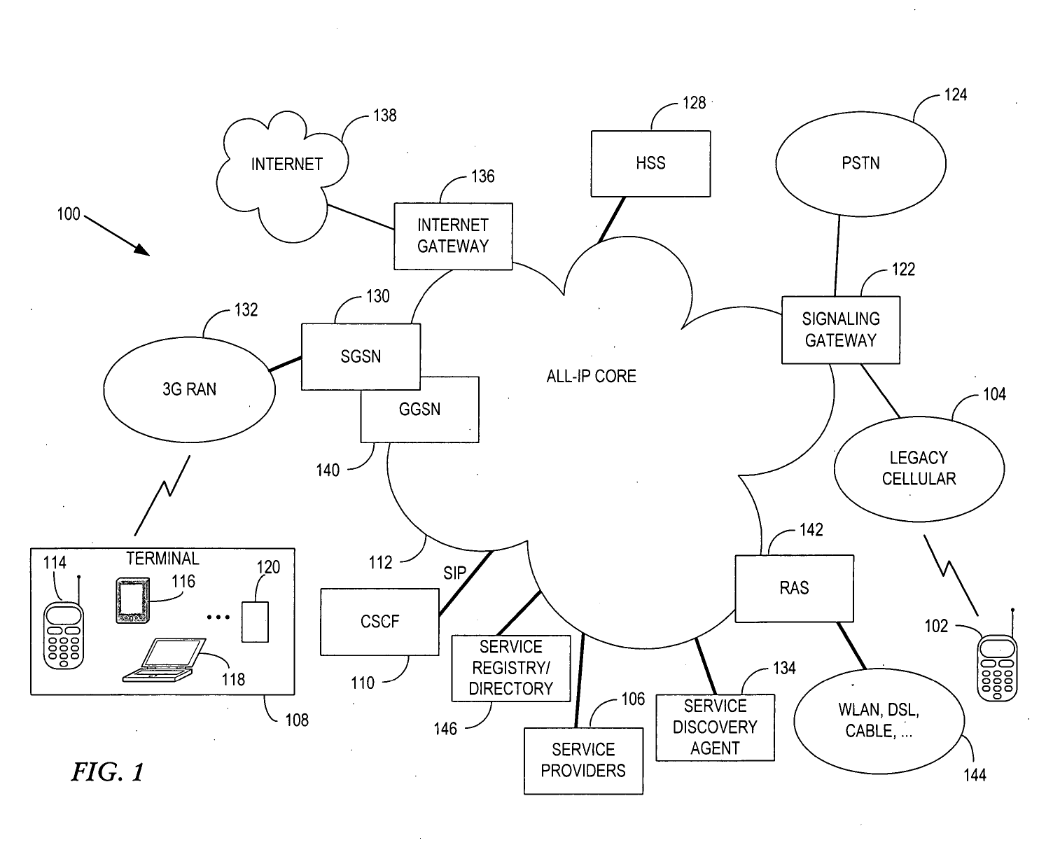

An exemplary system level diagram of communication system 100, in which the principles of the present invention may be implemented, is shown in FIG. 1. ALL-IP core 112 provides the common, IP based signaling core utilized by communication system 100 to integrate various fixed, mobile, and Internet networks. ALL-IP core 112 allows all communication services to be carried over a single network infrastructure, thus enabling the integration of voice, data, and multimedia services. Further, ALL-IP core 112 allows network resources to be used more efficiently, where increased capacity may be deployed as necessary to meet demand.

Communication system 100 is optimized to support multimedia services, where Call State Control Function (CSCF) 110 implementing SIP is a key ingredient in providing the multimedia services to all IP enabled devices. Although SIP's primary objective was meant for multimedia sessions, its scope may be extended to presence, gaming, Instant Messaging (IM), and service discovery, as well.

The wireless terminal 108 may represent any of a number of mobile communication devices, such as cellular telephone 114, personal digital assistant (PDA) 116, notebook or laptop computer 1118, or any other type of wireless terminal represented by device 120. 3rd Generation (3G) Radio Access Network (RAN) 132 represents a combination of all mobile radio standards, such as Global System for Mobile Communications (GSM)/Enhanced Data Rates for Global Evolution (EDGE) and Wideband Code Division Multiple Access (WCDMA). Each mobile radio standard having its own distinct network architectures and transport mechanisms that are fully integrated using the IP protocol, where Serving General Packet Radio Service (GPRS) Support Node (SGSN) 130 and Gateway GPRS Support Node 140 provides the RAN interface to ALL-IP core 112.

Network 144 provides WLAN, Digital Subscriber Line (DSL), and cable access to ALL-IP core 112 by Remote Access Server (RAS) 142. RAS 142 may include, for example, a Digital Subscriber Line Access Multiplexer (DSLAM) or a cable head end controller. To provide access to ALL-IP core 112 over a cable network, a head-end controller device (not shown) within RAS 142 connects to an IP router (not shown) that sends and receives the data from ALL-IP core 112. The controller interprets the data it receives from individual customers and keeps track of the services offered to each of them. The controller also modulates the data received from ALL-IP core 112 so that the head-end equipment can send it to a specific cable subscriber within network 144.

Communication system 100 supports Legacy Cellular systems 104 that offers communication support to legacy terminal 102, for example. Signaling gateway 122 performs all necessary Signaling System No. 7 (SS7) and Mobile Application Part (MAP) signaling conversions as necessary to provide SS7 over IP access from PSTN 124 and MAP over EP access from Legacy Cellular system 104 to ALL-IP core 112. In addition, signaling gateway 122 provides Short Message Service Center (SMSC) support and Multimedia Message Service Center (MMSC) support for any SMS and MMS operations as required by mobile terminal 102 and 108.

Internet 138 access from ALL-IP core 112 is provided through internet gateway 136 to allow accesses defined by Uniform Resource Locator (URL) and Uniform Resource Identifier (URI) address definitions. Home Subscriber Server (HSS) 128 provides ALL-IP core 112 with the many database functions that are required in ALL-IP networks. HSS 128, for example, may include a Home Location Register (HLR) and a Domain Name Server (DNS).

Service providers 106 provide consumer applications and services that are not easily provided within the circuit switched or packet core networks by themselves. Service groups having major relevance in 3G ALL-IP networks include information and entertainment content providers, communication, productivity enhancing services and business solutions. Accordingly, services that are timely, personalized, simple to complete, and location specific are provided to all consumers of communication system 100.

In the service discovery domain depicted in communication system 100, mobile terminals 108 and 102 require fast and precise results that utilize simple search logic. Some of the most important aspects associated with the mobile service discovery scenario are: implementation of an efficient search infrastructure concentrating on the content relative to the user of the mobile terminal; a simple user interface having ready made search templates for keyword searches; and a context based infrastructure. The context based infrastructure should take into account: the user profile and preferences, which may include previous search attempts and favorite services; mobility and the user's location; the mobile terminal device and profile that the user is presumably using; and the time of the search.

The process whereby a network entity first searches, then discovers, then finds the required service dynamically is called service discovery. A service is a function of many attributes, e.g., type of content, value of content, time, location, consumer identification, and consumer categorization. These attributes along with the context of the searching device make the search criteria a complex issue to handle. Moreover, the mobility aspect of the requesting entity and the requested service makes service discovery even more challenging.

Generally speaking, there are three entities involved during the process of service discovery. First, an entity called a client, which is trying to find or discover what it needs. The client entity may be a consumer, a device, or specific software executing within the device. Second, an entity called a service, e.g., as provided by service providers 106, which is being discovered by the client entity, that is capable of fulfilling the client's needs. Third, an entity called a registry, or directory, e.g. service registry/directory 146, which maintains a list of available services within, for example, communication system 100.

Service discovery spans different parts or domains in any given end to end scenario, depending on which device is searching/discovering and which content type is being discovered. In a first service discovery scenario, for example, service registry/directory 146 maintains a list of network resources which the client entity, e.g., mobile terminal 108, can discover. Basic network resources that are discoverable by the client entity may include, for example, Domain Name Servers (DNS) or Voice over IP (VoIP) gateways. Once the network resources are discovered, the services offered by the network resources, e.g., service providers 106, may include Mobile Information Device Profile (MIDP) applications hosted by a content provider, mobile commerce services hosted by a service portal, and/or customer services hosted by a department store, to name only a few.

In another service discovery scenario, a client entity, e.g., mobile phone 114, can directly search for applications in a neighboring device, e.g., PDA 116. In this instance, both mobile phone 114 and PDA 116 may be Bluetooth enabled, such that the Bluetooth SDP is used by mobile phone 114, for example, to automatically discover any services that may be offered by PDA 116. In yet another service discovery scenario, mobile terminal 108 may host a directory of network services. For example, mobile phone 114 may contain connection access points for GSM/GPRS services hosted within 3G RAN 132, or conversely, laptop 118 may contain access points for services hosted by WLAN network 144.

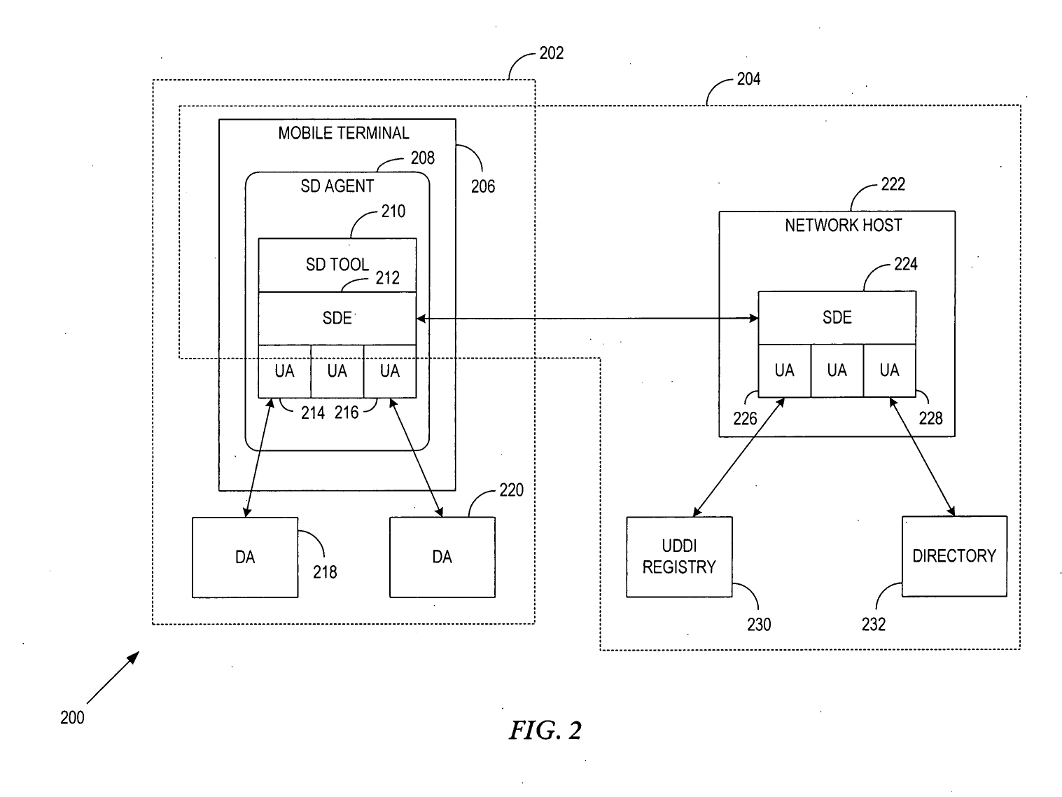

FIG. 2 illustrates an exemplary end to end architecture 200 that may be implemented in accordance with the present invention to accommodate the service discovery scenarios listed above, as well as many other service discovery scenarios not listed. For example, remote service discovery scenario 204 depicts an exemplary scenario, whereby Service Discovery Engine (SDE) 212 of mobile terminal 206 interacts with SDE 224 of network host 222 to discover services listed within Universal Description, Discovery, and Integration (UDDI) registry 230, or directory 232 via interaction with User Agents (UA) 226 and 228, respectively. SDE 224 may further conduct service discovery on behalf of mobile terminal 206 based upon queries received from SD agent 208. Once all services relating to the query have been located, a compilation of the search results may be uploaded to mobile terminal 206 in a single transaction.

In addition, local service discovery scenario 202 depicts a service discovery scenario within a localized region of mobile terminal 206, whereby a Bluetooth SDP, for example, is used for service discovery. In such an instance, UA 214 and 216 provide access to a Bluetooth SDP stack, whereby short range wireless transmission technology enables discovery of services advertised by, for example, Directory Agents (DA) 218 and 220.

Still other service scenarios exist, for example, whereby mobile terminal 206 may provide service registry functions to network host 222. In such a scenario, a hybrid service discovery scenario is implemented, whereby local service discovery scenario 202 is combined with remote service discovery scenario 204. In particular, SDE 224 of network host 222 interacts with SDE 212 of mobile terminal 206 to discover services advertised by DA 218 and 220. The services advertised by DA 218 and 220 are locally discovered, for example, via Bluetooth SDP exchange with UA 214 and 216 of mobile terminal 206. Other localized interconnection mechanisms, such as Infrared (IR) or WLAN, may also be used to offer services to network host 222 that are in proximity to mobile terminal 206.

Generally speaking, UA 214-216 and UA 226-228 are not relegated to any particular type of service discovery agent, but rather may be defined as Service Discovery Plug-Ins (SDPIs). In other words, depending upon the type of SDPI used to implement UA 214-216 and UA 226-228, they may take on any type of functionality required. Likewise, DAs 218-220 that are in contact with UAs 214 and 216, respectively, form the service registration portion of automated service discovery that is compatible with the particular type of UA plug in being used.

In one embodiment according to the present invention, for example, UAs 214-216 may represent user agents as defined by the SLP. SLP is currently being developed by the Internet Engineering Task Force (IETF) as a vendor independent standard for decentralized, lightweight, and extensible service discovery. SLP uses service Uniform Resource Locators (URLs), which define the service type and address for a particular service. Based on the service URLs, SDE 212 may browse available services within its domain, then may utilize the services that are selected.

In SLP operation, a Service Agent (SA) (not shown) broadcasts advertisements on behalf of a service via a service registration message (SrvMsg). The SrvMsg contains the URL for the advertised service and a set of descriptive attributes for the service. As centralized service information repositories, DAs 218-220 cache the service registration messages from the SAs and acknowledge the SrvMsg with a service acknowledgment message (SrvAck). UAs 214-216 are then able to send a service request message (SrvRqst) to DAs 218-220 to request the service's location. DAs 218-220 may then respond with a service reply message that includes the URLs of all services matched against the UA's request. Subsequently, UAs 214-216 may then access the service pointed to by the returned URL.

In another embodiment according to the present invention, UA 214-216 and DA 218-220 may instead take on functionality that is consistent with Jini technology, which is an extension of the Java programming language. Each Jini device (not shown) is assumed to have a Java Virtual Machine (JVM) running on it. The Jini architecture principle is similar to SLP, in that devices and applications register with a Jini network using a process called Discovery and Join.

To join a Jini network, a device or application places itself into the lookup table on a lookup server, which is a database for all services on the network (similar to the DA in SLP). Besides pointers to services, the lookup table can also store Java based program code for these services, which enables the services to upload device drivers and other programs to enable the user to access the service. When a client wants to use the service, the object code is downloaded from the lookup table to the JVM executing within the client. Whereas a service request in SLP returns a service URL, the Jini object code offers direct access to the service using an interface known to the client. Thus, the code mobility offered by Jini replaces the necessity of pre-installing drivers on the client.

In yet another embodiment according to the present invention, UA 214-216 and DA 218-220 may interact in accordance with the Salutation architecture that is being developed by an open industry consortium known as the Salutation Consortium. In Salutation, Salutation Managers (SLMs) behave as service brokers, whereby services register their capabilities with the SLM (similar to the DA of SLP). Clients may then query the SLM when they need a service (similar to the UA of SLP).

According to another exemplary embodiment of the present invention, a UPnP approach may be taken, whereby UAs 214-216 and DAs 218-220 are effectively replaced by the Simple Service Discovery Protocol (SSDP). SSDP uses HTTP over UDP and is thus designed for usage in IP networks, where peer to peer mechanisms are enabled for auto configuration of devices, service discovery, and control of services.

According to yet another exemplary embodiment of the present invention, UA 214-216 and DA 218-220 may operate in accordance with the Bluetooth SDP standard. Bluetooth is a low-power, short range, wireless radio system that operates in the 2.4 Gigahertz (GHz) Industrial, Scientific, and Medical (ISM) band to maximize international acceptance and employs a frequency hopping system to minimize interference. In particular, each of UA 214-216 and DA 218-220 may incorporate their own Bluetooth protocol stack, in which Bluetooth SDP is used to first locate services that are available on devices in the vicinity of the user and then utilize the located services.

At the bottom of the Bluetooth stack, the radio and base band layers provide the short range, frequency hopping radio platform. The Link Manager Protocol (LMP) handles data link setup and provides authentication and encryption services. The Logical Link Control and Adaptation Protocol (L2CAP) supports multiplexed connectionless and connection oriented communication over the LMP layer. Groups of up to eight Bluetooth devices can form ad hoc networks called piconets to communicate, share services, and synchronize data. In each piconet, a master device coordinates other Bluetooth devices, which can be participating in other piconet sessions.

The Bluetooth SDP provides a simple Application Programming Interface (API) for enumerating devices that are in range, which also allows for subsequent browsing of the services offered by the in range devices. Bluetooth also supports stop rules that limit the duration of searches or the number of Bluetooth enabled devices that are returned during the search. Client applications, e.g., SD agent 208 of mobile terminal 206, use the API to search for available services either by service classes, which uniquely identify types of devices or their corresponding attributes. Attributes that describe the services offered by a Bluetooth device are stored as a service record and are maintained by the device's SDP server. The Bluetooth SDP does not provide a mechanism for using discovered services, therefore, specific actions required to use the specific services offered by a Bluetooth device must be provided by a higher level protocol. The Bluetooth SDP does, however, define a standard attribute Protocol Descriptor List, which enumerates appropriate protocols for communicating with a service.

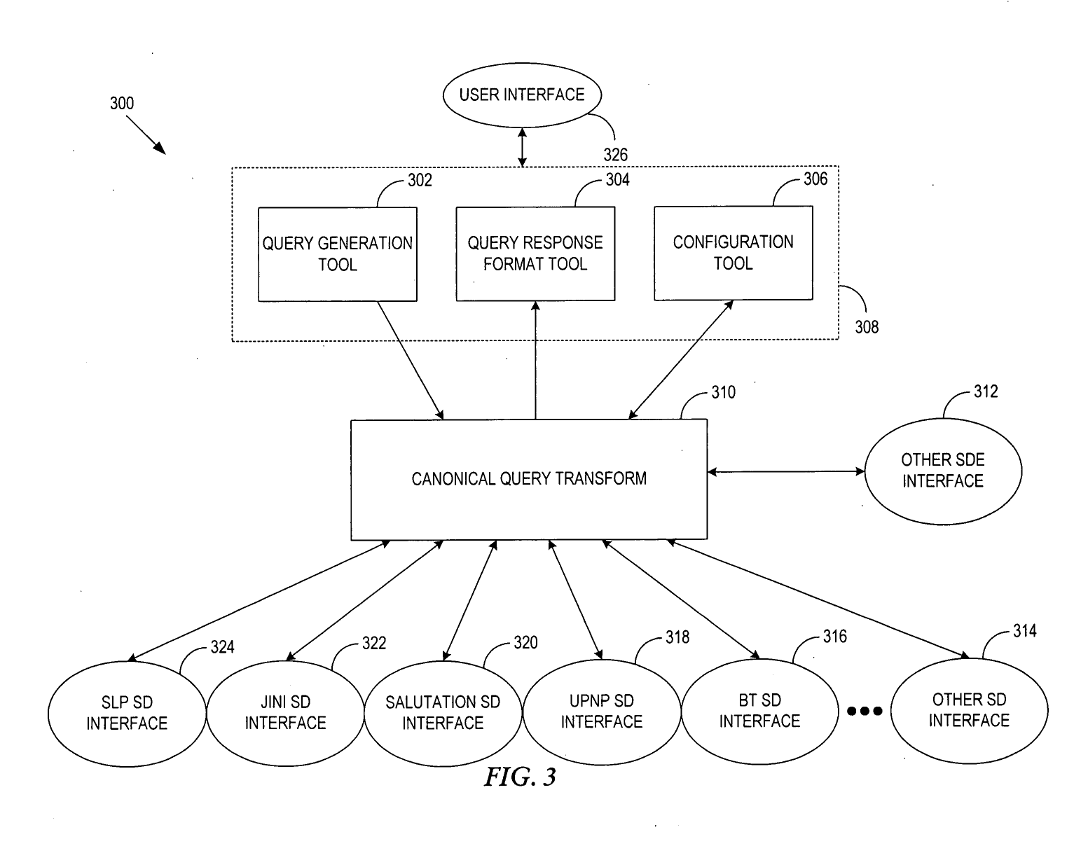

FIG. 3 illustrates an exemplary block diagram of SD agent 300 that corresponds to SD agent 208 of FIG. 2 in accordance with the present invention. SD Agent 300 may exist within mobile terminal 206 of FIG. 2 to provide service discovery capabilities in accordance with the present invention. Upon initialization, for example, SD agent 300 may attempt to automatically connect to another SDE in the network, e.g., SDE 224, via other SDE interface 312. The default URL of network host 222 may, for example, be configured by the user of mobile terminal 206 via configuration tool 306 to automatically connect to SDE 224 in much the same way that default home pages are currently programmed into Internet browsers. Once connected, Canonical Query Transform (CQT) 310 interacts with SDE 224 via other SDE interface 312 to retrieve default information from network host 222. The default information may consist of useful search categories or useful links contained within, for example, UDDI registry 230 or directory 232.

User interface 326 is provided by SD agent 300 to allow the user to perform a multitude of tasks in relation to the service discovery functions of SD agent 300 via SD tool 308. In particular, user interface 326 allows any number of control inputs from the user, via configuration tool 306 or query generation tool 302, such as keypad entry, verbal commands, pointing device entry, as well as command entry through the use of an acceleration/tilt sensing device. In addition, user interface 326 may provide tactile, visual, and/or audible feedback to the user of SD agent 300 via query response format tool 304 in order to communicate the results of any service discovery event generated by CQT 310. Further, the user may generate queries via query generation tool 302 that may then be issued to any of interfaces 312-324 via CQT 310.

CQT 310 illustrates an exemplary transform block of SDE 212 that allows generic SD queries that are generated by the user to be translated and subsequently issued via specific SD protocol interfaces 312-324. In particular, SLP SD interface 324 allows service discovery operations to be performed with SLP enabled services as discussed above. Similarly, SD interfaces 316-322 allows service discovery operations to be conducted with services conforming to the Bluetooth, UPnP, Salutation, and Jini specifications, respectively, also as discussed above. Generally speaking, other SDP interfaces 314 may be added to the functionality of SD agent 300, by simply installing the correct plug-in as necessary to implement the required SDP. Accordingly, as other SDPs become available in the future, their required support functions may easily be downloaded into SD agent 300.

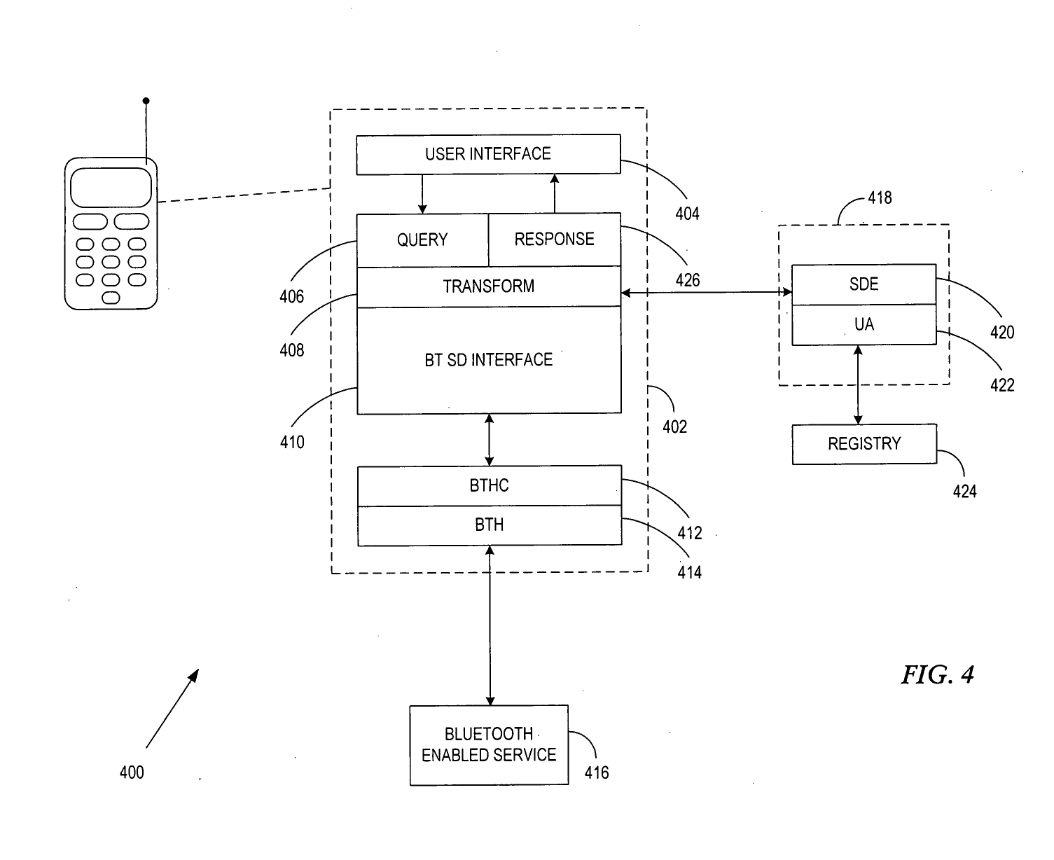

In order to discuss an exemplary aspect of the operation of SD agent 300, hybrid service discovery scenario 400 of FIG. 4 will now be discussed in relation to the service discovery of Bluetooth enabled service 416 that is proximately coupled to mobile terminal 402. Hybrid service discovery scenario 400 implements several forms of service discovery in accordance with the present invention. First, local service discovery of Bluetooth enabled service 416 is performed by mobile terminal 402 via a query issued by Bluetooth SD interface 410. Once discovered, the service offered by Bluetooth enabled service 416 is then consumed by mobile terminal 402 by performing a transform with transform block 408 of the data received, formatting the response with response block 426, and ultimately providing the response to user interface 404. Second, transform 408 is further accessed by SDE 420 of network host 418, whereby Bluetooth enabled service 416 is advertised in registry 424 for access by other network entities within the domain of network host 418.

Mobile terminal 402 may be implemented using a Series 60 Platform, for example, that is built upon the Symbian Operating System (OS) General Technology (GT). Symbian GT provides a fully object-oriented design, preemptive multi-tasking, and full support for client-server architecture. Symbian GT also provides the common core for API and technology, which is shared between all Symbian reference designs. Some of the major components supported by Symbian GT include a multimedia server for audio recording, playback, and image-related functionality, as well as a Personal Area Network (PAN) communication stack including infrared, Bluetooth and serial communication support. As such, Symbian GT allows the use of Bluetooth technology to allow proximity, wireless operations to utilize local service accessories. The number and type of local service accessories provided by the Bluetooth connection are virtually unlimited and they include for example; bar code readers, digital pens, health monitoring devices, Global Positioning System (GPS) receivers, enhanced video feeds, and video conferencing facilitation, to name only a few.

Communications between Bluetooth enabled service 416 and Bluetooth stack 412-414 is facilitated through the use of sockets, which are similar to those used by a TCP/IP connection. In Symbian GT, Bluetooth sockets are used to discover other Bluetooth devices, and to read and write data over a Bluetooth radio interface. The Bluetooth sockets API supports communication over both the L2CAP and RFCOMM layers of Bluetooth Host Controller (BTHC) 412. Not only does the Bluetooth socket API allow mobile terminal 402 to make a connection to Bluetooth enabled service 416, the Bluetooth socket API also allows the Bluetooth enabled service 416 to contact mobile terminal 402 for data transfer. The Bluetooth socket API has five key concepts: socket address, remote device inquiry, RFCOMM commands, L2CAP commands, and Host Controller Interface (HCI) commands. Structures and API's provided by the Symbian OS Bluetooth implementation are defined in Series 60 Software Development Kit (SDK) under the following header files: <bt_sock.h>, <btdevice.h>, <btextnotifiers.h>, <btsdp.h>, and <bttypes.h>.

Prior to socket connection, however, service discovery must be performed in order to identify potential Bluetooth enabled devices/services that are available for subsequent connection. The Bluetooth SDP resident within BTHC 412 performs this task by performing two main functions: discovery of devices and services within the local area, and the advertisement of services from the local device to network host 418. If, for example, Bluetooth enabled service 416 can provide locally generated image data streams of a video conference, then that service is made visible through transform 408 to SDE 420. Accordingly, the service is advertised in registry 424 by network host 418 via UA 422. In this way, the locally accessed services of Bluetooth enabled service 416 are made accessible by mobile terminal 402 to any network element within the domain of network host 418.

In order for a Bluetooth service to be advertised, it must first be represented by a service record and kept within an SDP database for access by other applications. The SDP database is implemented as a server within the Symbian OS and as such, other applications wishing to discover the services offered, must first establish a connection to the server and open a session on the server. The RSdp class within the Symbian OS API represents the SDP database server and allows an application to connect to it.

A service record in Symbian OS is created through the SDP database by managing a collection of service handles and their associated attributes that make up the service record. Each service record is identified by a Universally Unique Identifier (UUID), which is defined within the <bttypes.h> header file. Within each service record exists a service class and associated profile that is used to help generalize the types of services provided by the device. There are, for example, predefined service class numbers that may represent a Bluetooth enabled service and a more specific entry to define detailed aspects of the Bluetooth enabled service. In general, therefore, the service record contains a collection of attributes that are identified by an identification number that is of the TSdpAttributeID data type defined within the <btsdp.h> header file. Each service handle and the associated attributes are used by the SDP database to identify attributes and their values within the database.

The Symbian OS API provides the Bluetooth SDP with service search patterns and attribute search patterns that are used to facilitate the device and service discovery process. The service search pattern, for example, allows the Bluetooth SDP to discover and create a list of all available services within the local area, e.g., Bluetooth enabled service 416, where all services discovered in the local area are services that are advertised by their own SDP agent and identified by their respective service record UUIDs. Mobile terminal 402, via query 406, allows the user to create an attribute range that defines a list of attributes that are of interest to mobile terminal 402. Accordingly, attribute queries from query 406 result in only those attributes of the remote Bluetooth enabled devices/services that fall within the attribute range specified in the attribute search pattern. Once a device with a suitable service has been identified, mobile terminal 402 may query the service for more information, which may include requesting the available attributes of Bluetooth enabled service 416.

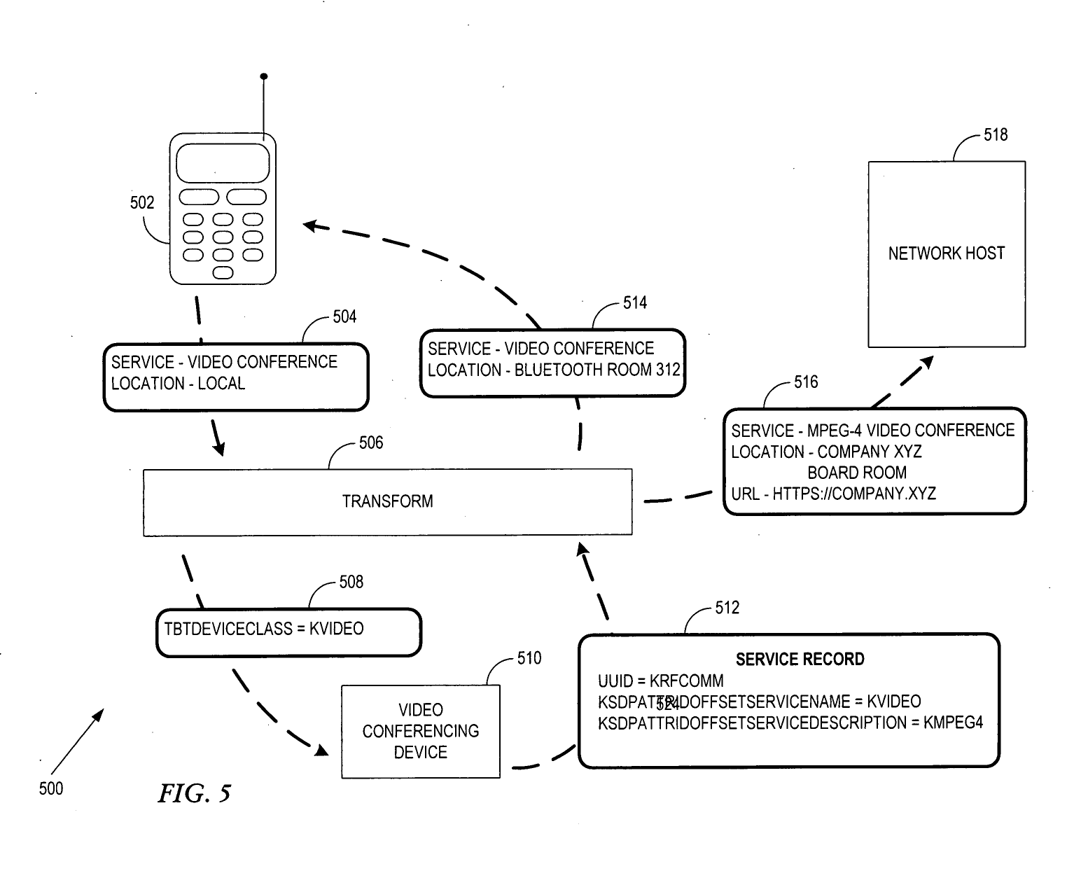

FIG. 5 illustrates exemplary flow diagram 500 illustrating a typical interaction between mobile terminal 502 and Bluetooth enabled, video conferencing device 508, which further illustrates hybrid service discovery scenario 400 of FIG. 4. In particular, through the use of query 406 and user interface 404, the user of mobile terminal 402 generates query 504, which generally describes the service requirements of the user. In general, query 504 establishes that the user wishes to find any local services that may offer video conferencing capability.

Transform 506 receives query 504 and subsequently translates query 504 into a selection parameter that is used by BT SD interface 410 to aid in its Bluetooth service discovery process. In particular, transform 506 may set the value of the TBTDeviceClass variable of the TBTDeviceSelectionParams class to KVIDEO. KVIDEO, for example, may correspond to a value of type const, that represents a Bluetooth enabled, video conferencing device. As such, BT SD interface 410 then limits the range of service discovery to only those devices which correspond to the video conferencing class of devices.

In response, the Bluetooth SDP agent of video conferencing device 510 responds with service record 512. Within service record 512, video conferencing device 510 indicates that the UUID is set to a value of type const KRFCOMM, which indicates that the RFCOMM protocol of BTHC 412 is to be used for data transfer between mobile terminal 502 and video conferencing device 510. In addition, the service name and service description have been set to const values of KVIDEO and KMPEG4, respectively. The const value KVIDEO may, for example, designate video conferencing device 510 as a video capture device, whereby the KMPEG4 const value further defines that the video format generated by video conferencing device 510 is Moving Pictures Experts Group version 4 (MPEG-4).

Transform 506 receives service record 512 and formats the data received into data that is discernable by the user of mobile terminal 502. In particular, message 514 is generated by transform 506 to indicate that a video conference service was indeed located and the location of the service indicates that it is a Bluetooth enabled service in, for example, room 312. The information reflected in message 514 may then be provided to the user of mobile terminal 502 via any one or all of visual, audible, or tactile queues via user interface 404.

In addition, the Bluetooth service discovery executed by mobile terminal 502 may be made available by transform 506 via message 516. In particular, message 516 indicates to network host 518 that an MPEG-4 video conference device is accessible from within Company XYZ via URL HTTPS://company.xyz. Thus, any device within the domain of network host 518 having appropriate security credentials may access the video conferencing data generated by video conferencing device 510. The actual data transfer, however, will take place directly from mobile terminal 502. In this case, mobile terminal 502 is acting as a mobile server, such that the proximately captured video data is first received from video conferencing device 510 and then made available to network host 518.

It should noted, that message 516 may be directed to network host 518 from mobile terminal 502 via any number of communication protocols. For example, SMS or MMS may be utilized to transfer message 516 via either an SMSC or an MMSC (not shown) contained within, for example, signaling gateway 122 of FIG. 1. SIP enabled messaging may also be invoked by mobile terminal 502 to send message 516 to network host 518. In a first example, the SIP method, MESSAGE, may be used to transport an instant message body containing message 516 to network host 518. Alternatively, a SIP session may be instantiated between mobile terminal 502 and network host 518 by using the INVITE method in conjunction with CSCF 110 of FIG. 1. Other IP enabled protocols may also be used, such as HTTP, to provide the connection between mobile terminal 502 and network host 518. In some instances, which are dependent upon proximity, the connection between mobile terminal 502 and network host 518 may also be provided through the use of Bluetooth, WLAN, or IR methods.

It should be noted that although a Bluetooth service discovery scenario has been explained in detail, other service discovery scenarios relating to SD interfaces 314, and 318-324 operate in much the same fashion. Generally speaking, regardless of the service discovery protocol being used, CQT 310 of FIG. 3 performs the required translations: to provide the user queries in the format required by the various SD interfaces; and to provide the results of the user queries in a format that are user friendly to the user.

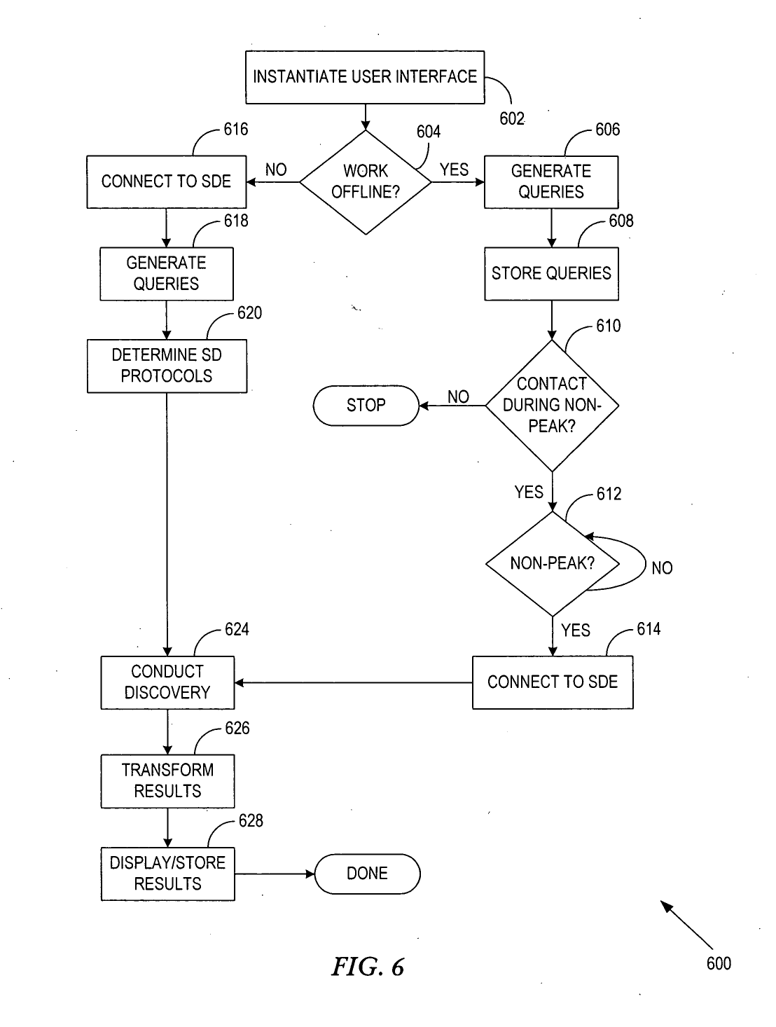

A flow diagram of exemplary service discovery scenario 600 is illustrated in FIG. 6 in accordance with the principles of the present invention. It should be noted that the SD agent according to the present invention may be instantiated within any network entity, whether it be mobile or fixed. As such, the SD agent may be executed, for example, within either of mobile terminal 206 or network host 222 of FIG. 2. For illustrative purposes, however, service discovery scenario 600 is assumed to commence within mobile terminal 206 and will be discussed in relation to FIGS. 1-5. In such an instance, SDE 224 of network host 222 is considered to be the default SDE.

In step 602, user interface 404 is instantiated, whereby the ability to configure SD agent 208 is provided. SD agent 208 is highly configurable by the user of mobile terminal 206, whereby many features may be initially programmed to suit the needs of the user. For example, the user may wish to configure the URL for a default SDE, e.g., SDE 224, to be used for connection at startup. Conversely, the user may configure SD agent 208 to automatically initialize into an off-line status, whereby no default SDE is utilized at startup. The user may wish to pre-configure SD agent 208 with non-peak hours of operation, such that any queries built while off-line are later executed during the non-peak hours of operation of communication system 100. The user may wish to configure the depth of the history queue (not shown), in which queries generated either on-line or off-line may be saved for a configurable amount of time. It is apparent to one of ordinary skill in the art, therefore, that other configuration options of SD agent 208 are possible, but are not listed here in the interest of brevity.

Once configured, the user of mobile terminal 206 may elect in step 604 to work off line without connecting to any SD engine, or conversely may elect to connect to an SDE immediately. If the user elects to work off line, then the YES path from step 604 is selected and queries similar to that of query 504 are generated in step 606 and stored in step 608 for later use. The user may wish to contact either his default SDE during non-peak hours, in which case the YES path of step 610 is taken, or conversely the user may wish to terminate the current service discovery session, in which case the NO path of step 610 is taken. If contact with the default SDE is desired during the non-peak hours, then the YES path of step 610 is taken, where no further service discovery action is taken until the non-peak window of time has arrived. Once the non-peak window of time has arrived, connection to the default, or other, SDE is performed in step 614 and service discovery is commenced at step 624.

If, on the other hand, the user wishes to work on-line, then the NO path of step 604 is taken. SD agent 208 may have been configured to automatically connect to the default SDE, or conversely, the user may be given the opportunity to connect to any SDE of choice via other SDE interface 312 as in step 616. Once connected, queries such as query 504 may be generated as in step 618 and subsequently queued for execution. SD agent 208 then determines the number of SDPs that are available for use as in step 620. In particular, a service discovery interface, e.g., interfaces 314-324, exists for each UA previously installed which correspond to UAs 214-216. Each UA installed may be thought of as a plug in, such that interoperability with a substantially unlimited number of SDPs may be enabled through the installation of a substantially unlimited number of UAs. The user may have pre-configured SD agent 208 to utilize any one or more of SD interfaces 314-324. Conversely, the user may be provided the opportunity to choose among the SD interfaces that are available for use.

Once the default, or other, SDE has been selected, and all other SD interfaces have been chosen, service discovery execution may commence as in step 624. Results of the service discovery are then collected from the various SDPs and then transformed by CQT 310 as in step 626. Once transformed, the results of the service discovery may then be displayed and stored as in step 628, whereby the user is then able to invoke the services discovered at that time.

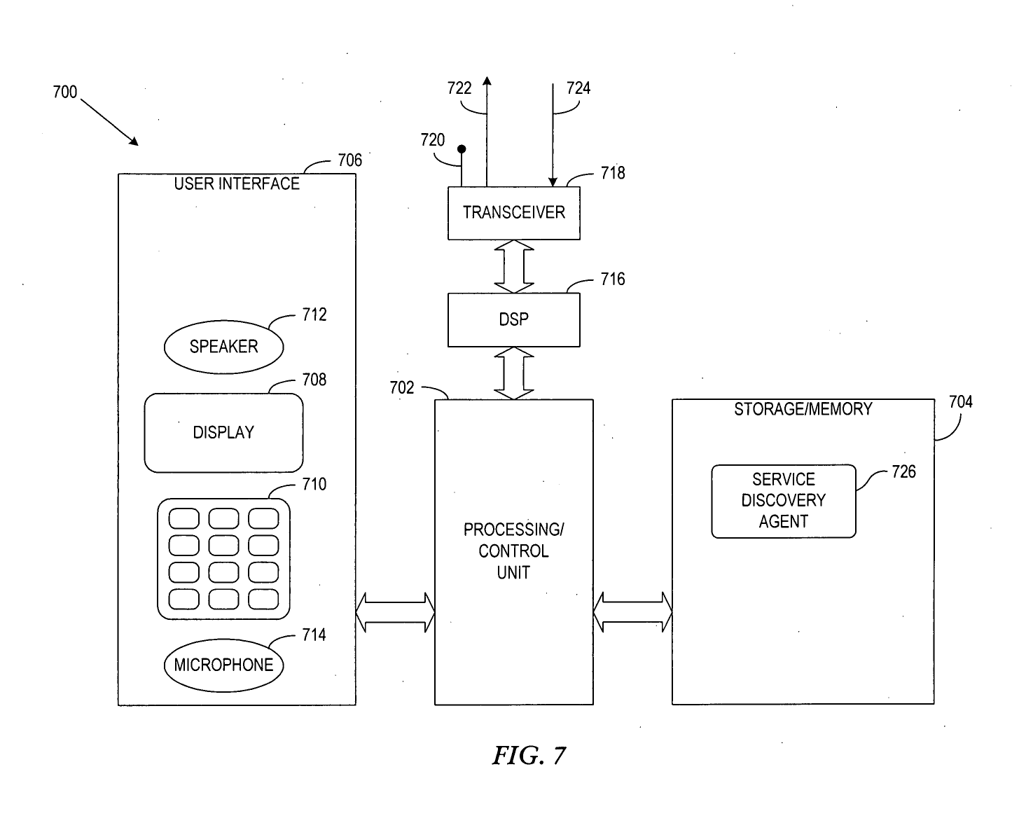

The invention is a modular invention, whereby processing functions within either a mobile terminal or a hardware platform may be utilized to implement the present invention. The mobile terminals may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various service discovery functions described herein. An example of a representative mobile terminal computing system capable of carrying out operations in accordance with the invention is illustrated in FIG. 7. Those skilled in the art will appreciate that the exemplary mobile computing environment 700 is merely representative of general functions that may be associated with such mobile devices, and also that landline computing systems similarly include computing circuitry to perform such operations.

The exemplary mobile computing arrangement 700 suitable for service discovery functions in accordance with the present invention may be associated with a number of different types of wireless devices. The representative mobile computing arrangement 700 includes a processing/control unit 702, such as a microprocessor, reduced instruction set computer (RISC), or other central processing module. The processing unit 702 need not be a single device, and may include one or more processors. For example, the processing unit may include a master processor and associated slave processors coupled to communicate with the master processor.

The processing unit 702 controls the basic functions of the mobile terminal, and also those functions associated with the present invention as dictated by service discovery agent 726 available in the program storage/memory 704. Thus, the processing unit 702 in conjunction with service discovery agent 726 is capable of initiating service discovery functions associated with the present invention. The program storage/memory 704 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 704 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The processor 702 is also coupled to user-interface elements 706 associated with the mobile terminal. The user-interface 706 of the mobile terminal may include, for example, a display 708 such as a liquid crystal display, a keypad 710, speaker 712, and microphone 714. These and other user-interface components are coupled to the processor 702 as is known in the art. Other user-interface mechanisms may be employed, such as voice commands, switches, touch pad/screen, graphical user interface using a pointing device, trackball, joystick, or any other user interface mechanism.

The mobile computing arrangement 700 also includes conventional circuitry for performing wireless transmissions. A digital signal processor (DSP) 716 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 718, generally coupled to an antenna 720, transmits the outgoing radio signals 722 and receives the incoming radio signals 724 associated with the wireless device.

The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a service discovery system and method in accordance with the present invention.

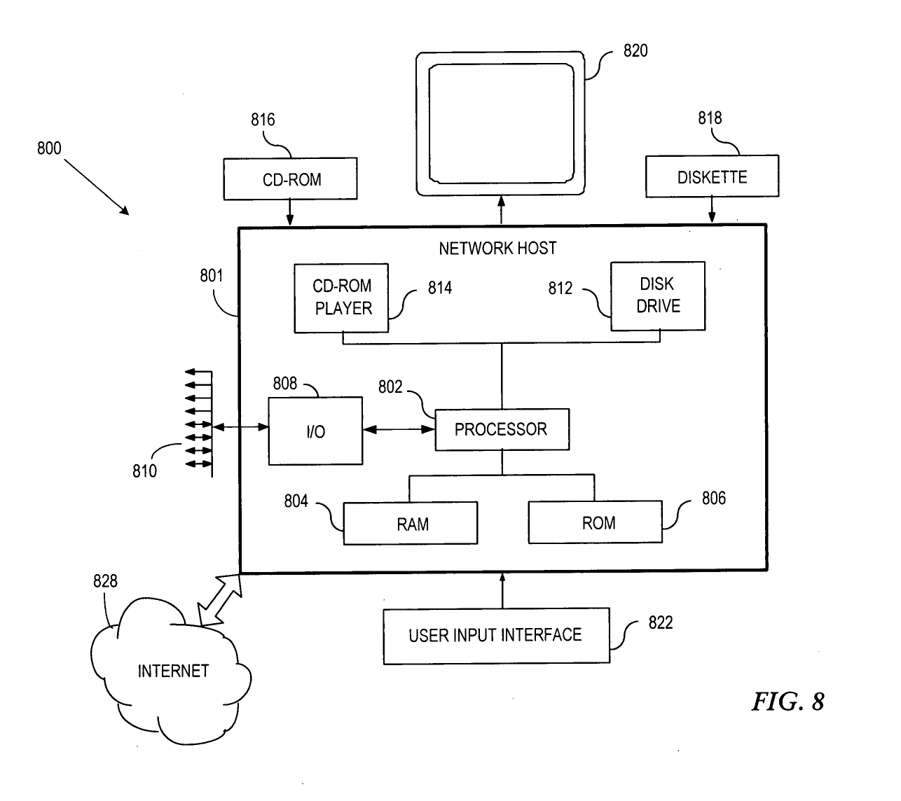

The network hosts or other systems for providing service discovery functions in connection with the present invention may be any type of computing device capable of processing and communicating digital information. The network hosts utilize computing systems to control and manage the service discovery activity. An example of a representative computing system capable of carrying out operations in accordance with the invention is illustrated in FIG. 8. Hardware, firmware, software or a combination thereof may be used to perform the various service discovery functions and operations described herein. The computing structure 800 of FIG. 8 is an example computing structure that can be used in connection with such a service discovery system.

The example computing arrangement 800 suitable for performing the service discovery activity in accordance with the present invention includes network host 801, which includes a central processor (CPU) 802 coupled to random access memory (RAM) 804 and read-only memory (ROM) 806. The ROM 806 may also be other types of storage media to store programs, such as programmable ROM (PROM), erasable PROM (EPROM), etc. The processor 802 may communicate with other internal and external components through input/output (I/O) circuitry 808 and bussing 810, to provide control signals and the like. External data storage devices, such as UDDI registries or directories, may be coupled to I/O circuitry 808 to facilitate service discovery functions according to the present invention. Alternatively, such databases may be locally stored in the storage/memory of the server 801, or otherwise accessible via a local network or networks having a more extensive reach such as the Internet 828. The processor 802 carries out a variety of functions as is known in the art, as dictated by software and/or firmware instructions.

Network host 801 may also include one or more data storage devices, including hard and floppy disk drives 812, CD-ROM drives 814, and other hardware capable of reading and/or storing information such as DVD, etc. In one embodiment, software for carrying out the service discovery operations in accordance with the present invention may be stored and distributed on a CD-ROM 816, diskette 818 or other form of media capable of portably storing information. These storage media may be inserted into, and read by, devices such as the CD-ROM drive 814, the disk drive 812, etc. The software may also be transmitted to network host 801 via data signals, such as being downloaded electronically via a network, such as the Internet. Network host 801 is coupled to a display 820, which may be any type of known display or presentation screen, such as LCD displays, plasma display, cathode ray tubes (CRT), etc. A user input interface 822 is provided, including one or more user interface mechanisms such as a mouse, keyboard, microphone, touch pad, touch screen, voice-recognition system, etc.

The network host 801 may be coupled to other computing devices, such as the landline and/or wireless terminals via a network. The server may be part of a larger network configuration as in a global area network (GAN) such as the Internet 828, which allows ultimate connection to the various landline and/or mobile client/watcher devices.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A method for providing uniform service discovery through the use of a plurality of service discovery protocols, comprising:
generating service discovery queries from a user interface;
translating the service discovery queries into formats required by each of the plurality of service discovery protocols;
receiving results indicative of services found from each of the plurality of service discovery protocols in response to the service discovery queries; and
translating the results into a uniform format for display on the user interface, wherein the uniform format is independent of the plurality of service discovery protocols.

2. The method according to claim 1, further comprising translating the service discovery queries into a format required by a service discovery engine.

3. The method according to claim 2, wherein the service discovery engine compiles service discovery results in response to the service discovery queries and provides the service discovery results to the user interface.

4. The method according to claim 3, wherein the service discovery engine gains access to the plurality of services found.

5. The method according to claim 4, wherein the service discovery engine provides access to the plurality of services found to a plurality of network entities within a domain of the service discovery engine.

6. The method according to claim 1, wherein the plurality of service discovery protocols includes Bluetooth service discovery protocol.

7. The method according to claim 1, wherein the plurality of service discovery protocols includes one or more of Service Location Protocol (SLP), Salutation, Jini, Bluetooth, and Universal Plug and Play (UPnP).

8. A service discovery system, comprising:
a first service discovery agent coupled to receive service discovery queries in a user format and coupled to transform the user formatted service discovery queries into a plurality of formats each dependent upon a plurality of respective service discovery protocols; and
a second service discovery agent coupled to receive service discovery queries from the first service discovery agent and in response, to provide service discovery responses to the first service discovery agent, wherein the second service discovery agent is coupled to access services discovered by the first service discovery agent.

9. The service discovery system according to claim 8, wherein the first service discovery agent comprises a service configuration tool coupled to allow first discovery agent operation independent of second service discovery agent operation.

10. The service discovery system according to claim 9, wherein the first service discovery agent further comprises a canonical query transform coupled to provide the plurality of transformed formats.

11. The service discovery system according to claim 10, wherein the canonical query transform is configured with a programmable number of format capabilities.

12. The service discovery system according to claim 11, wherein the programmable number of format capabilities is dependent upon a number of plug in modules installed within the canonical query transform.

13. The service discovery system according to 12, wherein the programmable number of format capabilities includes Bluetooth service discovery protocol.

14. The service discovery system according to 12, wherein the programmable number of format capabilities includes one or more of Service Location Protocol (SLP), Salutation, Jini, Bluetooth, and Universal Plug and Play (UPNP).

15. A network host, comprising:
means for receiving service discovery queries from a service discovery agent;
means for discovering services within a domain of the network host in response to the service discovery queries;
means for providing the services discovered within the domain of the network host to the service discovery agent; and
means for accessing services within a domain of the service discovery agent.

16. The network host according to claim 15, further comprising means for providing access to the services within the domain of the service discovery agent to network entities within the domain of the network host.

17. A computer-readable medium having instructions stored thereon which are executable by a network host processing system for facilitating service discovery by performing steps comprising:
receiving service discovery queries from a service discovery agent;
discovering services within a domain of the network host in response to the service discovery queries;
providing results of the services discovered within the domain of the network host to the service discovery agent; and
accessing services within a domain of the service discovery agent.

18. The computer-readable medium according to claim 17, further comprising instructions to allow network entities within the domain of the network host to access services within the domain of the service discovery agent.

19. A mobile terminal wirelessly coupled to a network having a service discovery engine, the mobile terminal comprising:
a memory capable of storing a service discovery agent coupled to locate services having a plurality of service description protocols in response to received user queries having a user format;
a processor coupled to the memory and configured by the service discovery agent to enable service discovery query exchange with the service discovery engine; and
a transceiver configured to facilitate the service discovery query exchange with the service discovery engine, wherein the transceiver further facilitates access to the services having a plurality of service description protocols by the service discovery engine.

20. The mobile terminal according to claim 19, wherein the service discovery agent comprises a service configuration tool coupled to allow service discovery agent operation independent of the service discovery engine.

21. The mobile terminal according to claim 20, wherein the service discovery agent further comprises a canonical query transform coupled to translate the user queries into a format required by the plurality of service description protocols.

22. The mobile terminal according to claim 21, wherein the canonical query transform is further coupled to translate responses from the plurality of service description protocols into the user format.

23. A computer-readable medium having instructions stored thereon which are executable by a mobile terminal processing system for providing service discovery by performing steps comprising:
receiving service discovery queries in a user format;
transforming the user formatted service discovery queries into a plurality of formats relating to a plurality of service discovery protocols;
receiving service discovery results in a plurality of service discovery protocols in response to the service discovery queries; and
transforming the service discovery results into the user format.

24. The computer-readable medium according to claim 23, further comprising instructions to perform steps comprising:
providing the service discovery queries to a network host; and
receiving responses from the network host in response to the provided service discovery queries.
